(19) United States
(12) Patent Application Publication
(10) Pub. No.: US 2020/0327244 A1
(43) Pub. Date: Oct. 15, 2020

(54) SYSTEM FOR DATABASE ACCESS RESTRICTIONS USING IP ADDRESSES

(71) Applicant: Walmart Apollo, LLC, Bentonville, AR (US)

(72) Inventors: Oscar Blass, Bentonville, AR (US); Derrick Gene Wright, Springdale, AR (US); Gauravdeep Juneja, Bangalore (IN)

(21) Appl. No.: 16/418,808

(22) Filed: May 21, 2019

(30) Foreign Application Priority Data
Apr. 12, 2019 (IN) 201941014882

(51) Int. Cl. G06F 21/62

(52) U.S. Cl. CPC G06F 21/6218

(57) ABSTRACT

Examples provide database access restrictions by an access manager component using predefined set of allowed IP addresses on a per-table, per-column, per-row and/or per-cell level. The access manager component permits a user to define a set of allowed IP addresses and/or a range of allowed IP addresses for connecting to a database and/or accessing data within a database. The access manager component applies table-level restrictions, column-level restrictions, row-level restrictions and/or cell-level restrictions to grant or deny read and write access to data within the database based on the IP address of the device attempting to access the data.

### BACKGROUND

Databases frequently store sensitive information requiring access restrictions to prevent unauthorized users from viewing or altering the data stored there. Currently, data on a database can be protected at the network layer by requiring a user to login to a server using valid credentials prior to the server permitting the user from connecting to the system including the database. However, current systems typically require only user name and password credentials to grant access to the data. If the credentials are compromised, data may be at risk. Therefore, available network layer security options, such as firewalls and login protocols may be suboptimal in some situations.

### SUMMARY

Some examples provide a system for application-level database access restrictions using internet protocol (IP) addresses. The system includes at least one processor communicatively coupled to a memory. A data storage device includes a database storing data. A property manager component adds a set of database-level restrictions onto at least a portion of data in the database. The set of database-level restriction includes at least one allowed IP address for accessing the at least the portion of the data in at least one column or at least one row of the database. A request manager component receives a request from an application to access the portion of the data in the at least one column or the at least one row of the database via a network. A permissions component compares a requesting IP address associated with the request to the at least one allowed IP address for accessing the portion of the data to determine whether the IP address is allowed to access the data and whether a type of access requested is permitted by the set of database-level restrictions. The permissions component grants the request on condition the set of database-level restrictions allows the requesting IP address and the type of access associated with the portion of the data. An error handling component outputs an error to a user device associated with the request.

Other examples provide a computer-implemented method for restricting database access. A user device receives a request to access data in a column or a row of the database via a network. A database manger component identifies a requesting IP address associated with the request. A permissions component compares the requesting IP address associated with the request to a set of allowed IP address associated with the data in the column or the row of the database. The permissions component permits the requested access to the data by the user device if the requesting IP address is included within the set of allowed IP addresses and a type of access associated with the request is allowed by a set of permissions assigned to the requesting IP address. The type of access includes read access or write access. An error handling component denies the requesting access if the requesting IP address is absent from the set of allowed IP addresses or the type of access requested is disallowed by the set of permissions assigned to the requesting IP address at the database-level.

Still other examples provide a computer storage media having computer-executable instructions for customized database access restrictions at the application level. The computer-executable instructions are executed by a computer cause the computer to add a set of database-level restrictions onto at least a portion of data in a database on a data storage device. The set of database-level restriction include a set of allowed IP addresses for accessing the at least the portion of the data in a table, a column or a row of the database. A requesting IP address associated with a read or write request received from an application is compared with the set of allowed IP addresses prior to permitting access to the at least the portion of the data in the table, column or the row of the database. The read or write request is granted if the requesting IP address is included within the set of allowed IP addresses for the table, the column or the row of the database associated with the request. Error handling is initiated if the requesting IP address is absent from the set of allowed IP addresses.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for enabling database-level access restrictions.

FIG. 2 is an exemplary block diagram illustrating an access manager component for creating database-level access restrictions on a database.

FIG. 3. is an exemplary block diagram illustrating a database including per-table, per-column, per-row and/or per-cell restrictions.

FIG. 4. is an exemplary block diagram illustrating a set of allowed internet protocol (IP) addresses.

FIG. 5 is an exemplary block diagram illustrating a database having IP address-based restrictions.

FIG. 6 is an exemplary block diagram illustrating a set of user devices sending a request to access data on a database having IP address-based restrictions.

FIG. 7 is an exemplary flow chart illustrating operation of the computing device to apply IP address-based restrictions on an application attempting to access data on a database.

FIG. 8 is an exemplary flow chart illustrating operation of the computing device to restrict access to data on a database based on requesting IP address and type of access requested.

FIG. 9 is an exemplary flow chart illustrating operation of the computing device to enforce per-table, per-column, per-row and/or per-cell restrictions.

FIG. 10 is an exemplary flow chart illustrating operation of the computing device to apply per-column and per-row restrictions.

FIG. 11 is an exemplary flow chart illustrating operation of the computing device to apply restrictions to read and write requests associated with data on a database.

FIG. 12 is an exemplary flow chart illustrating operation of the computing device to apply database-level restrictions on data.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Referring to the figures, examples of the disclosure enables a system for adding internet protocol (IP) or network range restrictions at a database level to protect data stored in the database. In some examples, the system protect sensitive columns, rows and/or tables from within the database such that only connections from certain IP addresses or subnets can access data on the database. This decreases the risk of unauthorized access to data. To obtain unauthorized access, the malicious user would be required to have unauthorized credentials, know which machine is allowed access and connect to the database from the permitted machine on the network to access or extract the data.

In some examples, the system restricts data access at the database layer by an IP or subnet value which allows data access restrictions to be enforced at the application layer without reconfiguring the application at lower network layers. This improves user convenience and simplifies authorization of access requests by enabling authorized users to obtain access to data based on IP address checks without requiring user action, such as, entering passwords which can be cumbersome for users and unreliable where credentials have become compromised.

The system in other examples checks permissions before serving requests by sending error messages if an action violates restrictions associated with a particular table, column, row and/or cell. This enables improved data security and improved flexibility implementing data access restrictions at a granular (per-table, per-column, per-row and/or per-cell) level within the database.

The system permits easy addition or removal of IP or network range level values as a property of the database to control access to tables, columns, rows or even individual cells within the database. This improves user ease and efficiency in implementing, updating, and/or removing data access restrictions to data within the database.

The IPs can be specifically granted or given in classless inter-domain routing (CIDR) range. This permits the user to perform quick set up to allow the entire network to be granted permissions. CIDR is a method for allocating IP addresses and IP routing based on variable-length subnet masking (VLSM). This allows the specification of arbitrary-length prefixes.

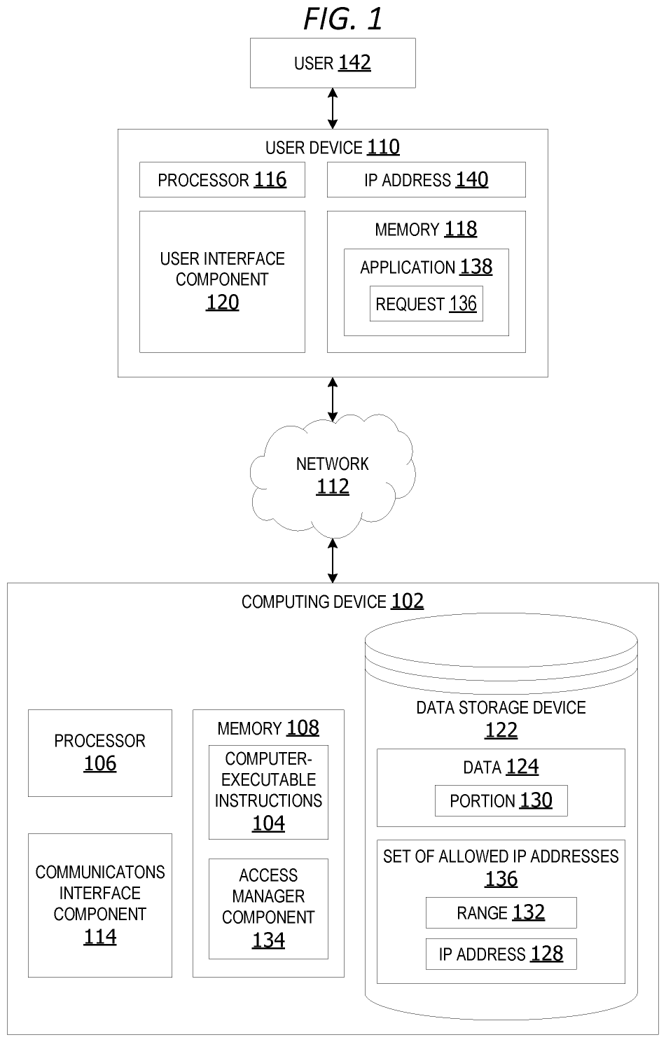

Referring again to FIG. 1, an exemplary block diagram illustrates a system 100 for enabling database-level access restrictions. In the example of FIG. 1, the computing device 102 represents any device executing computer-executable instructions 104 (e.g., as application programs, operating system functionality, or both) to implement the operations and functionality associated with the computing device 102. The computing device 102, in some examples, includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102 in other examples can optionally include a user interface component (not shown).

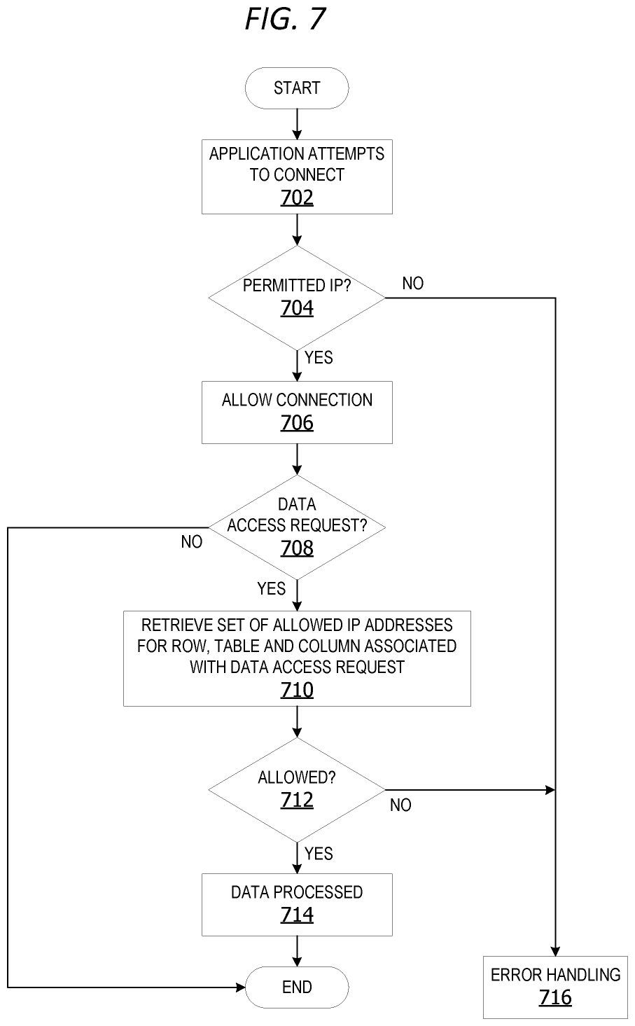

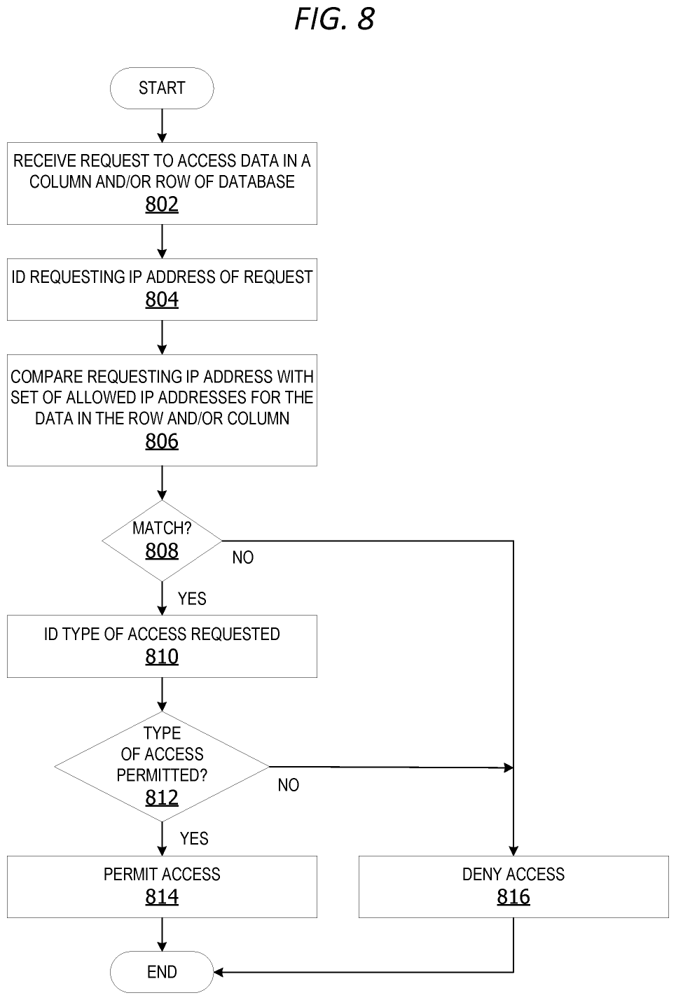

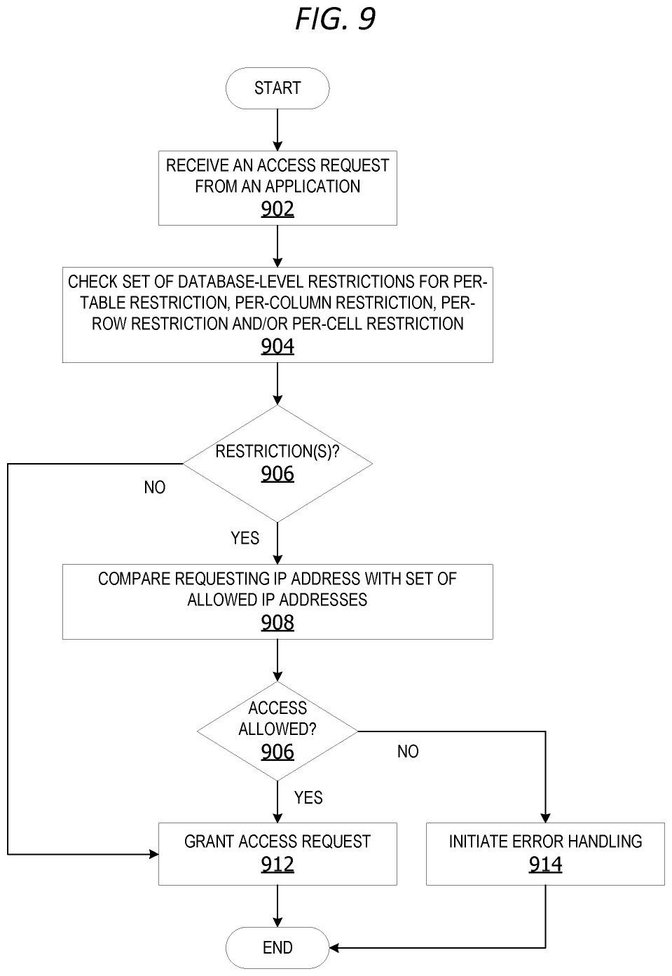

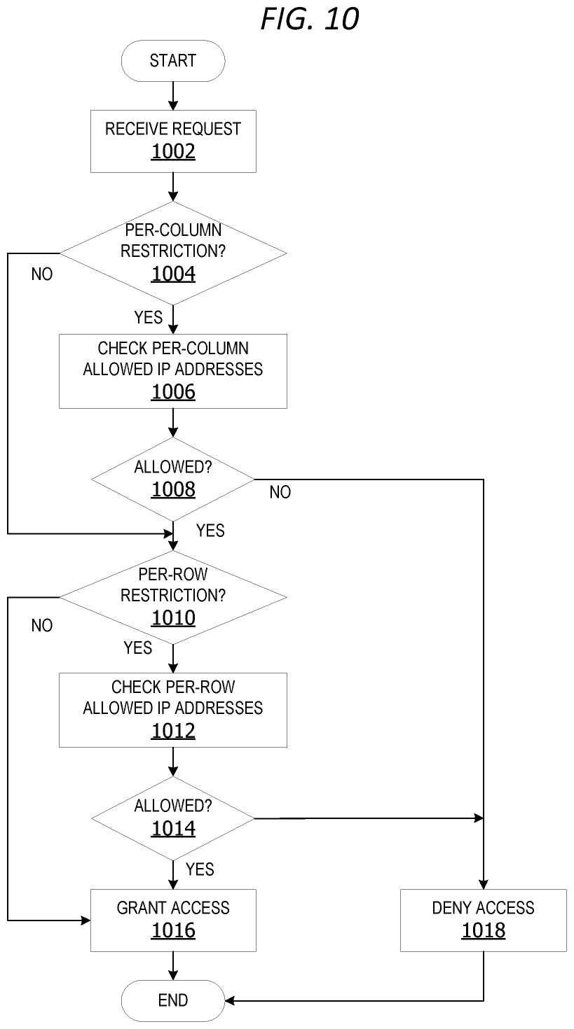

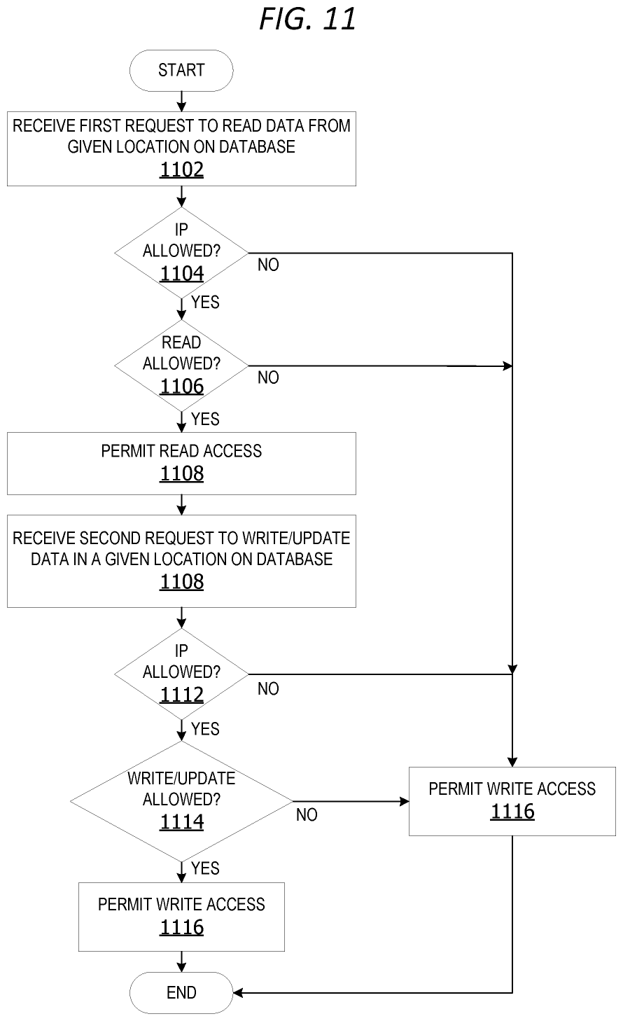

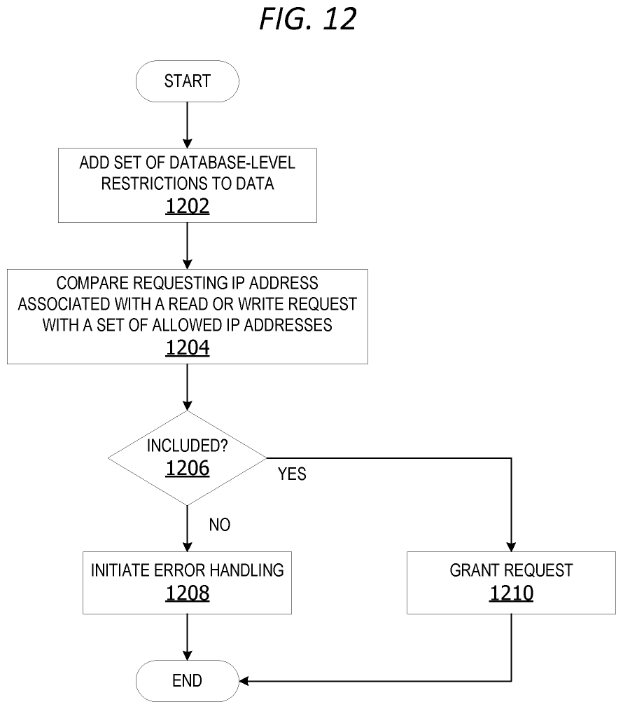

The processor 106 includes any quantity of processing units, and is programmed to execute the computer-executable instructions 104. The computer-executable instructions 104 is performed by the processor 106, performed by multiple processors within the computing device 102 or performed by a processor external to the computing device 102. In some examples, the processor 106 is programmed to execute instructions such as those illustrated in the figures (e.g., FIG. 7, FIG. 8, FIG. 9, FIG. 10, FIG. 11 and FIG. 12).

The computing device 102 further has one or more computer-readable media such as the memory 108. The memory 108 includes any quantity of media associated with or accessible by the computing device 102. The memory 108, in these examples, is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN. The term “Wi-Fi” as used herein refers, in some examples, to a wireless local area network using high frequency radio signals for the transmission of data.

In some examples, the system 100 optionally includes a communications interface component 114. The communications interface component 114 includes a network interface card and/or computer-executable instructions (e.g., a driver) for operating the network interface card. Communication between the computing device 102 and other devices, such as but not limited to the user device 110, can occur using any protocol or mechanism over any wired or wireless connection. In some examples, the communications interface component 114 is operable with short range communication technologies such as by using near-field communication (NFC) tags.

The user device 110 represents any device executing computer-executable instructions. The user device 110 can be implemented as a mobile computing device, such as, but not limited to, a wearable computing device, a mobile telephone, laptop, tablet, computing pad, netbook, gaming device, and/or any other portable device. The user device 110 includes at least one processor 116 and a memory 118. The user device 110 can also include a user interface component 120.

The user interface component 120, in some examples, includes a graphics card for displaying data to the user and receiving data from the user. The user interface component 120 can also include computer-executable instructions (e.g., a driver) for operating the graphics card. Further, the user interface component 120 can include a display (e.g., a touch screen display or natural user interface) and/or computer-executable instructions (e.g., a driver) for operating the display. The user interface component 120 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the user device 142 in one or more ways.

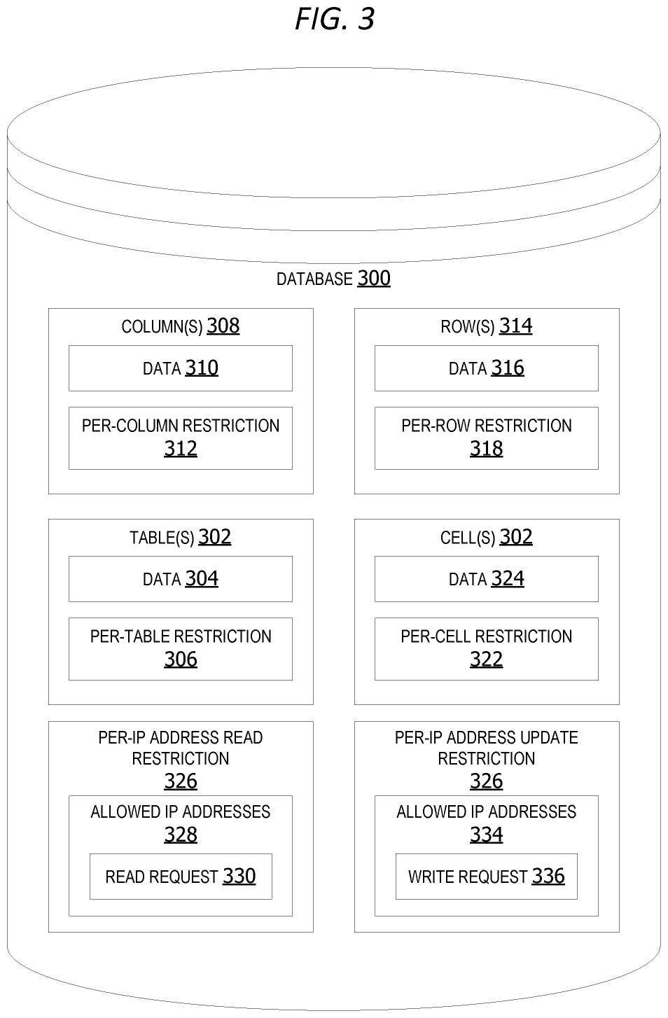

The system 100 can optionally include a data storage device 122 for storing data 124, such as, but not limited to a set of one or more allowed IP addresses 126. The data storage device 122 can include one or more different types of data storage devices, such as, for example, one or more rotating disks drives, one or more solid state drives (SSDs), and/or any other type of data storage device. The data storage device 122, in some non-limiting examples, includes a redundant array of independent disks (RAID) array. In other examples, the data storage device 122 includes a database, such as, but not limited to, the database 300 in FIG. 3.

The set of allowed IP addresses 126 in some examples includes at least one allowed IP address 128 for accessing at least a portion 130 of the data 124 in a database on the data storage device 122. The set of allowed IP addresses in other examples includes at least one range 132 of allowed IP addresses. The range 132 includes a first IP address and a second IP address defining the range 132.

The data storage device 122 in this example is included within the computing device 102 or associated with the computing device 102. In other examples, the data storage device 122 includes a remote data storage accessed by the computing device via the network 112, such as a remote data storage device, a data storage in a remote data center, or a cloud storage.

The memory 108 in some examples stores one or more computer-executable components, such as, but not limited to, the access manager component 134. In some examples, the access manager component 134 receives a data access request 136 from an application 138 running on the user device 110. The request 136 is a request to access (read data or write data) in a table, column, row or cell (column and row) within a database on the data storage device 122 via the network. The access manager component 134 identifies the IP address 140 associated with the user device 110. The IP address 140 is the requesting IP address associated with the request 136. The access manager component 134 compares the IP address 140 with the set of allowed IP addresses 126. If the IP address 140 matches an allowed IP address 128 in the set of allowed IP addresses 126 or if the IP address 140 is included within the range 132 of allowed IP addresses 126 associated with the portion 130 of the data 124 associated with the request 136. The access manager component 134 permits the requested access to the data by the user device 110 on condition the requesting IP address 140 is included within the set of allowed IP addresses 126. The user device 110 is denied access if the requesting IP address is absent from the set of allowed IP addresses 126.

The permissions in some examples can be set up by specifically granting permissions to individual IP addresses or by granting permissions to IP address ranges (IP address blocks), such as subnets via CIDR.

The access manager component in this example is located on a computing device 102. In other examples, the access manager component is executed on a processor and memory located on the data storage device.

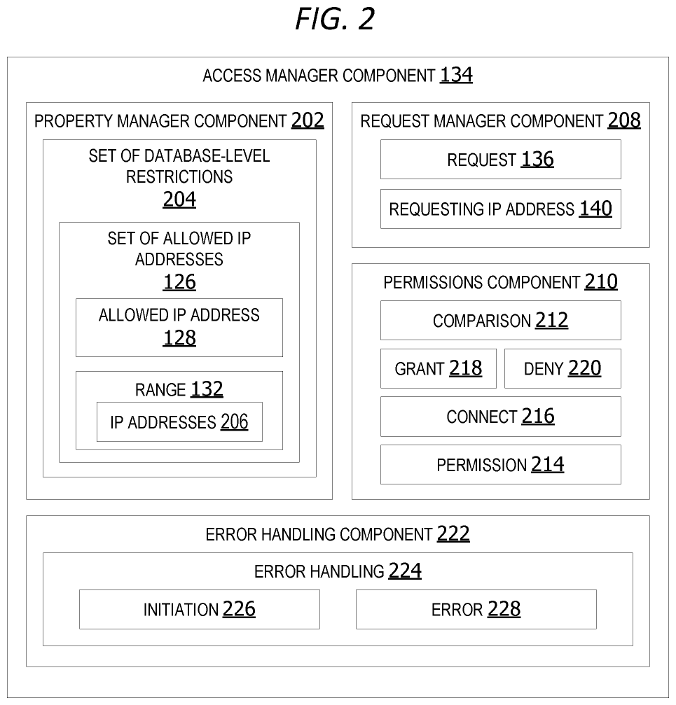

FIG. 2 is an exemplary block diagram illustrating an access manager component 134 for creating database-level access restrictions on a database. The access manager component 134 in some examples includes a property manager component 202 configured to add a user-defined set of database-level restrictions 204 associated with at least a portion of data in the database. The set of database-level restrictions 204 includes one or more allowed IP addresses for accessing at least the portion of the data in at least one table, column and/or row of the database. The set of allowed IP addresses 126 can include individual allowed IP addresses 128 or one or more ranges of allowed IP addresses 206, such as the range 132.

A request manager component 208 receives a request 136 from an application to access the portion of the data in the database table, column, row and/or cell via a network. The permissions component 210 performs a comparison 212 of the requesting IP address 140 associated with the request 136 to the set of allowed IP addresses 126 for accessing the portion of the data. The permissions component 210 determines whether the IP address 140 is allowed to access the data and whether a type of access requested by the user device is permitted by the set of database-level restrictions 204. The permissions component 210 grants permission 214 for the user device to connect 216 to the database if the IP address 140 matches an allowed IP address 128 for connecting to the database. Likewise, the permissions component 210 determines whether to grant 218 or deny 220 the request 136 to read data or write data to the database if the set of database-level restrictions 204 includes the requesting IP address in the set of allowed IP addresses for reading data or writing data to the relevant table, column, row and/or cell of the database associated with the read or write data request.

In some examples, an error handling component 222 performs initiation 226 of error handling 224 if the requesting IP address 140 is not an IP address allowed to read or write data to the table, column, row and/or cell associated with the access request. In other examples, the error handling component 222 outputs an error 228 to the user device if the request is denied by the permissions component 210.

In some examples, the error handling component outputs the error 228 message and does not permit the user device to access the data, but the user device is not disconnected from the system. In these examples, the user device can make a different data access request associated with a different table, column or row of data. The user device may be granted access to other data based on the requesting IP address even if the user device is denied access to some of the data.

FIG. 3. is an exemplary block diagram illustrating a database 300 including per-table, per-column, per-row and/or per-cell restrictions. In this example, one or more table(s) 302 storing data 304. A per-table restriction 306 on the data 304 can include a set of allowed IP addresses limiting/restricting access to the data 304 based on the IP address of the user device attempting to access the data 304. The per-table restriction can include a restriction on user devices permitted to connect to the database, read the data and/or write to data 304 on the table.

One or more column(s) 308 in a table within the database 300 can include a per-column restriction 312 limiting access to the data 310 in the column based on the IP address of the user device requesting access to the data. The per-column restriction can include a restriction on user devices permitted to connect to the database, read the data and/or write to data 310 within a specified column in a selected table of the database 300.

One or more row(s) 314 in a table within the database 300 can include a per-row restriction 318 limiting access to the data 316 in the row based on the IP address of the user device requesting access to the data. The per-row restriction can include a restriction on user devices permitted to connect to the database, read the data and/or write to data 316 within a specified row in a table on the database 300.

One or more cell(s) 320 in a table within the database 300 can include a per-cell restriction 322 limiting access to the data 324 in the cell based on the IP address of the user device requesting access to the data. The per-cell restriction can include a restriction on user devices permitted to connect to the database, read the data 324 and/or write to data 324 within a specified cell in a table on the database 300.

A per-IP address read restriction 326 includes allowed IP addresses 328 associated with read requests 330 to specified data in a table, row, column or cell of the database 300. If a read request is received from an IP address identified in the allowed IP addresses 328 or a range of allowed IP addresses, the read request is granted (access to read data is permitted). If the read request originated from a computing device having an IP address not included within the allowed IP addresses or a range of allowed IP address, the read access is not permitted.

A per-IP address update restriction 332 includes allowed IP addresses 328 associated with write requests 336 to specified data in a table, row, column or cell of the database 300. If a write request is received from an IP address identified in the allowed IP addresses 334 or a range of allowed IP addresses, the write request is granted (access to read data is permitted). If the write request originated from a computing device having an IP address not included within the allowed IP addresses or a range of allowed IP address, the write access is not permitted.

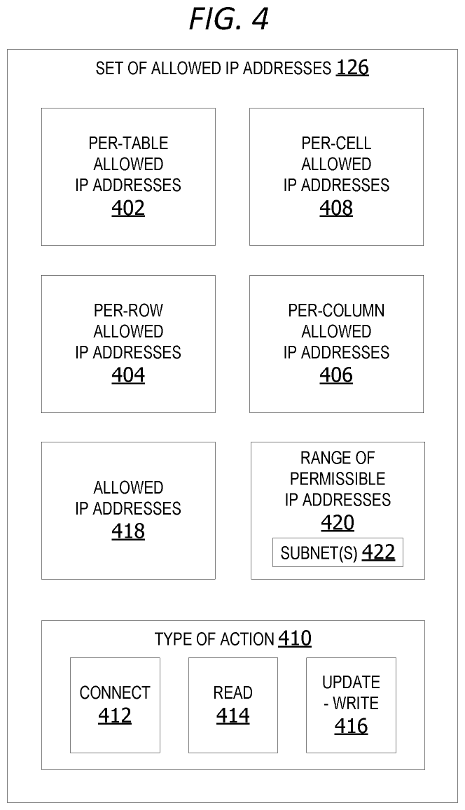

FIG. 4. is an exemplary block diagram illustrating a set of allowed IP addresses 126. The set of allowed IP addresses 126 can include one or more per-table allowed IP addresses 402 defining one or more IP addresses allowed to access data in a selected table in a database. The set of allowed IP addresses 126 can include one or more per-row allowed IP addresses defining one or more IP addresses allowed to access data in a selected row of a table on the database.

The set of per-column allowed IP addresses 406 in other examples includes one or more IP addresses allowed to access a selected column within a table associated with the database. The per-cell allowed IP addresses 408 defines one or more IP addresses allowed to access data in a selected cell (row and column combination) of a selected table of a database.

The type of action 410 permitted by the per-table, per-column, per-row and/or per-cell restrictions can include access to connect 412 to the database, access to read 414 data from a table, column, row and/or cell or access to update 416 (write) data to a table, column, row and/or cell associated with the database.

The set of allowed IP addresses 126 in some examples includes individual IP addresses 418. In other examples, the set of allowed IP addresses 126 includes a range of permissible IP addresses 420. The range of permissible IP addresses 420 can include IP addresses associated with one or more subnets 422. A subnet refers to a subnetwork. A subnet includes a range of IP addresses associated with reserve space for internal networks. Subnets can be used to increase the security of data stored within the subnets via the database-level access restrictions. In other words, only user requests coming from computing devices within an internal subnetwork can be permitted to access data in certain tables, columns, rows or cells to further limit access and provide additional layers of protection to more sensitive data.

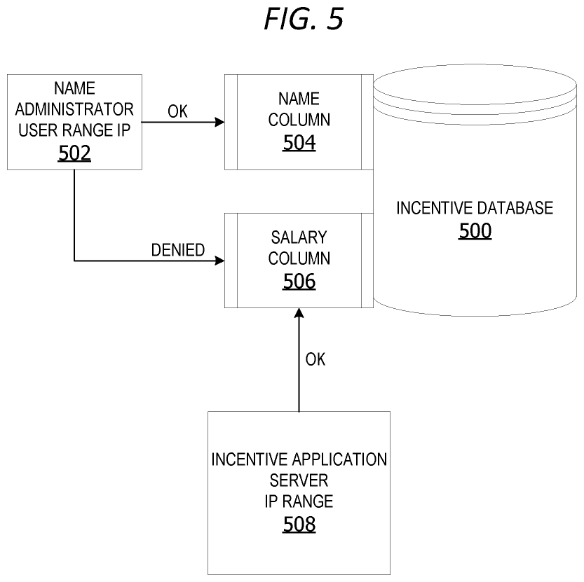

FIG. 5 is an exemplary block diagram illustrating a set of user devices sending a request to access data on a database 500 having IP address-based restrictions. The database 500 is a database storing data, such as, but not limited to, the database 300 in FIG. 3. A set of allowed IP addresses 502 in this example includes a range of IP addresses allowed to access a column 504 in a table on the database 500 containing “name” data. A request for access to the column 504 coming from a user device having an IP address in the IP range specified in the set of allowed IP addresses 502 is granted. However, a request for access to data in a different “salary” column 506 coming from the same IP address would be denied if the IP address was not included in another separate set of allowed IP addresses 508 for the selected column 506. Thus, the same user device can be permitted to access data in one column while being denied access to data in the same table located in another different column.

In this non-limiting example, a request for access to data in the “salary” column 506 coming from an application running on a computing device having an IP address in an IP range specified in the second set of allowed IP addresses 508 is allowed.

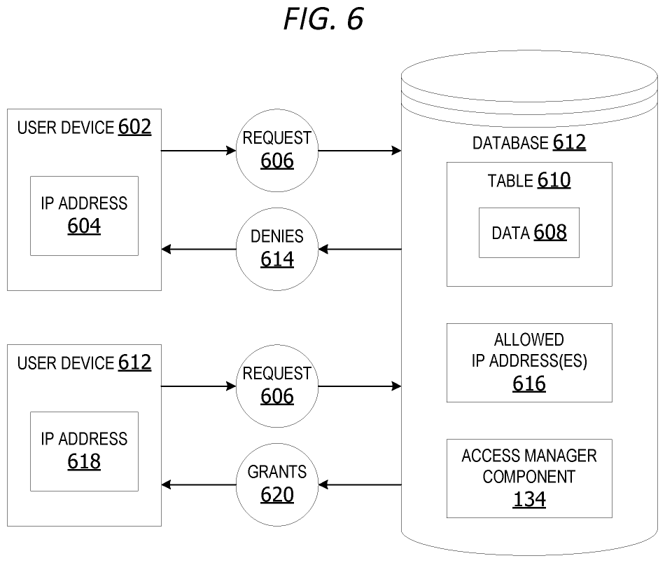

FIG. 6 is an exemplary block diagram illustrating a set of user devices sending a request to access data on a database 612 having IP address-based restrictions. In this example, a user device 602 having an IP address 604 sends a request 606 to access data 608 in a table 610 on the database 612. The access manager component 134 denies 614 access response if the IP address 604 is not found in the allowed IP address(es) 616. However, if the same request 606 is received from a second user device 616 having an IP address 618 in the allowed IP address(es) 616, the access manager component 134 grants 620 the request and permits the user device to access the data 608.

FIG. 7 is an exemplary flow chart illustrating operation of the computing device to apply IP address-based restrictions on an application attempting to access data on a database. The process shown in FIG. 7 is performed by an access manager component, executing on a computing device, such as the computing device 102 in FIG. 1.

The process begins when an application attempts to connect with a database at 702. The database is a database, such as, but not limited to, the database 300 in FIG. 3, the database 500 in FIG. 5 and/or the database 612 in FIG. 6. The application can be any type of application running on a client user device, such as, but not limited to, the application 138 in FIG. 1.

The access manager component determines if the connection request should be permitted based on the IP address of the user device attempting to connect at 704. If the IP address is an allowed IP address for connecting, the connection is allowed at 706. If the application makes a data access request at 708, the access manager component retrieves a set of allowed IP addresses for table, row and column associated with the data access request at 710. The access manager component determines if the data access is allowed based on the set of allowed IP addresses at 712. If yes, the data is processed by the application at 714. The process terminates thereafter.

If the IP address is not permitted to connect at 704, the access manager component initiates error handling at 716. The process terminates thereafter.

Returning to 712, if the request data access is not permitted for the requesting IP address, the access manager component initiates application error handling at 716. The process terminates thereafter.

While the operations illustrated in FIG. 7 are performed by a computing device, aspects of the disclosure contemplate performance of the operations by other entities. In a non-limiting example, a cloud service performs one or more of the operations.

FIG. 8 is an exemplary flow chart illustrating operation of the computing device to restrict access to data on a database based on requesting IP address and type of access requested. The process shown in FIG. 8 is performed by an access manager component, executing on a computing device, such as the computing device 102 in FIG. 1.

The process begins when a request to access data is received in a column and/or row of a database at 802. The access manager component identifies a requesting IP address of the user device sending the request at 804. The access manager component compares the requesting IP address with the set of allowed IP addresses for the data in the row and/or column of the table at 806. The access manager component determines if the requesting IP address matches an allowed IP address or an IP address within an allowed IP address range at 808. If yes, the access manager component identifies a type of access requested at 810. The access manager component determines if the type of access is permitted based on the IP address of the user device sending the request at 812. If yes, the system permits the requested access at 814. The process terminates thereafter.

Returning to 808, if the access manager component determines the requesting IP address does not match an allowed IP address, the access manager component denies access at 816. The process terminates thereafter.

Likewise, if the access manager component determines the type of access is not permitted based on the requesting IP address at 812, the access manager component denies access at 816. The process terminates thereafter.

While the operations illustrated in FIG. 8 are performed by a computing device, aspects of the disclosure contemplate performance of the operations by other entities. In a non-limiting example, a cloud service performs one or more of the operations.

FIG. 9 is an exemplary flow chart illustrating operation of the computing device to enforce per-table, per-column, per-row and/or per-cell restrictions. The process shown in FIG. 9 is performed by an access manager component, executing on a computing device, such as the computing device 102 in FIG. 1.

The process begins by receiving an access request from an application at 902. The access manager component checks a set of database-level restriction for per-table restriction, per-column restriction, per-row restriction, and/or per-cell restriction at 904. The access manager component determines if restriction(s) apply to the request at 906. If yes, the access manager component compares the request IP address with the set of allowed IP addresses associated with the data access requested at 908. The access manager component determines if the requested access is allowed at 910. If yes, the access manager component grants the access request at 912. The process terminates thereafter.

Returning to 906, if no restrictions apply to the data associated with the request, the access request is granted at 912. The process terminates thereafter.

If the requesting IP address does not match an allowed IP address or fit within the range of allowed IP addresses, the access manager component initiates error handling at 914. The process terminates thereafter.

While the operations illustrated in FIG. 9 are performed by a computing device, aspects of the disclosure contemplate performance of the operations by other entities. In a non-limiting example, a cloud service performs one or more of the operations.

FIG. 10 is an exemplary flow chart illustrating operation of the computing device to apply per-column and per-row restrictions. The process shown in FIG. 10 is performed by an access manager component, executing on a computing device, such as the computing device 102 in FIG. 1.

The process begins by receiving a request to access data on a database. The access manager component determines if a per-column restriction applies at 1004. If yes, the access manager component checks the per-column allowed IP addresses at 1006. The access manager component determines if the requesting IP address matches a per-column allowed IP address at 1008. If yes, the access manager component determines if per-row restrictions apply to the data access requested at 1010. If yes, the access manager component checks per-row allowed IP addresses applicable to the request at 1012. The access manager component determines if the IP address is allowed at 1014. If yes, the access manager component grants access at 1016. The process terminates thereafter.

Returning to 1008, if the access is not allowed based on the per-column allowed IP addresses, the access manager component denies the access at 1018. The process terminates thereafter.

If the request is allowed based on the per-column allowed IP addresses at 1006 and there are no applicable per-row restrictions at 1010, the access manager component grants the access to the data at 1016. The process terminates thereafter.

Returning to 1014, if the access is not allowed based on the per-row allowed IP addresses, the access manager component denies the access at 1018. The process terminates thereafter.

While the operations illustrated in FIG. 10 are performed by a computing device, aspects of the disclosure contemplate performance of the operations by other entities. In a non-limiting example, a cloud service performs one or more of the operations.

FIG. 11 is an exemplary flow chart illustrating operation of the computing device to apply restrictions to read and write requests associated with data on a database. The process shown in FIG. 11 is performed by an access manager component, executing on a computing device, such as the computing device 102 in FIG. 1.

The process begins by receiving a first request to read data from a given location on a database at 1102. The access manager component determines if the requesting IP address is allowed at 1104. If the requesting IP address is not allowed, the access manager component denies the request at 1118. The process terminates thereafter.

If the IP address is allowed at 1104, the access manager component determines if a read of the data is allowed based on the requesting IP address at 1106. If no, the access manager component denies the request at 1118. The process terminates thereafter.

If the read access is permitted at 1106, the access manager component permits the read access at 1108. The access manager component receives a second request to write/update data in a given location on the database at 1110. The access manager component determines if access to the data is allowed based on the requesting IP address at 1112. If no, the access manager component denies the request at 1118. The process terminates thereafter.

Returning to 1112, if the IP address is allowed to access the data, the access manager component determines if the write/update is allowed at 1114 based on the requesting IP address. If yes, the access manager component permits the write access. The process terminates thereafter.

If the write is not allowed at 1114, the access manager component denies the request at 1118. The process terminates thereafter.

While the operations illustrated in FIG. 11 are performed by a computing device, aspects of the disclosure contemplate performance of the operations by other entities. In a non-limiting example, a cloud service performs one or more of the operations.

FIG. 12 is an exemplary flow chart illustrating operation of the computing device to apply database-level restrictions on data. The process shown in

FIG. 12 is performed by an access manager component, executing on a computing device, such as the computing device 102 in FIG. 1.

The process begins by adding a set of database-level restrictions to data at 1202. The access manager component compares requesting IP address associated with a read or write request with a set of allowed addresses at 1204. The access manager component determines if the requesting IP address is included in the set of allowed IP addresses at 1206. If no, error handling is initiated at 1208. The process terminates thereafter.

Returning to 1206, if the requesting IP address is not included within the set of allowed IP addresses, the access manager component grants the request at 1210. The process terminates thereafter.

While the operations illustrated in FIG. 12 are performed by a computing device, aspects of the disclosure contemplate performance of the operations by other entities. In a non-limiting example, a cloud service performs one or more of the operations.

### ADDITIONAL EXAMPLES

In some examples, the system adds an attribute indicating IP addresses of servers permitted to access data at the table, row, column, or row-column (cell) level of a database. If a read or update of a given row is performed from a server that is isn't authorized based on the IP address of the server, the system generates an error. In other examples, the set of allowed IP addresses (list of allowed servers) can include a subnet (range) of servers allowed to access data. This enables the system to support complex applications.

The system, in other examples, provides for adding one or more properties to a database to allow IP Address or network IP Address range restrictions to a database system to deny connections, deny updates, and deny reads to particular tables, rows, columns, or row-column combinations. Before read or update operations are performed, the database determine if the client IP address is permitted to perform the requested operation. Operations can include connect, update (write), or read. Support for internet protocol version 6 (IPv6) and IPv4 can be covered. Restricting data access at the database layer by IP or subnet value can be achieved using other identifiers such a Mac address for further restriction. This allows restrictions at the application layer (layer 7) without reconfiguring applications at lower network layers (Layer 3, for example). The system sends error messages if restrictions placed on the table, row, or column are violated. This enables protecting data against unauthorized access while simplifying security management for the system.

Moreover, the system can, in still other examples, provide access restrictions for specific tables in a database, apply additional restrictions to selected rows and/or columns of data within each protected table, as well as specifying customized access restrictions for data in specific cells (row-column combination) within a given table for layers of access restrictions within a single table.

In an illustrative example, the ABCNUMBER column of a NAME table and/or BENEFITS table can be restricted for reading from the server with IP address 10.192.66.4 or IP address range of 10.192.66.1-255 addresses. In this manner, the database is an access management tool for storing data in a more secure manner.

In another example if an application ABCAPP requests access to data associated with another DEFAPP, the database authorized the access based on its IP address. If the ABCAPP runs on multiple servers or a certain subnet (set of IP addresses), the system can include a range of allowed IP addresses set to allow the data read. Currently these types of restrictions are implemented at the network layer. The access manager component creates additional restrictions into the database layer to add new layers of security and additional flexibility of partial functionality based on connection IP to application developers. This improves security and effectiveness of restrictions to sensitive data for improved reliability and prevention of unauthorized access based on the source (IP address) of access requests.

In another example scenario, if a table has ten rows, the property setting can limit IP addresses in Range “A” to rows one through five (1-5) and IP addresses in Range “B” to rows six through ten (6-10). Also, Row three, column five can be accessible to a user associated with a specified IP address associated with a machine (user device) belonging to the user.

The access manager component in some examples permits users to configure security in the database with greater flexibility and granular control at a per-table, per-column, per-row and/or per-cell basis. Additional flexibility can also be realized when applications can access certain data and behave differently (type of action) based on the source of the IP address associated with each incoming request. In this manner, the system enables additional layers of security to prevent unauthorized access to data where access is only granted to trusted machines or a machine in a trusted range attempting to extract sensitive data.

The system in some examples permits a user to customize control of which user devices and/or locations can access and update data at the application layer without altering system infrastructure. The system creates access restrictions based on IP addresses coming into the dbase. In other words, the access manager component controls which IP addresses are allowed to access selected content in a database. This is another layer of security over other existing firewalls. Even if user credentials, such as, user name and password, are compromised, the data is still secured from any access attempts coming from computing devices which are not identified in the set of allowed IP addresses. In this manner, only trusted devices are permitted to access data adding an additional layer of protection on top of existing network level security.

Furthermore, in still other examples, the system permits a user to segment applications and tables based on who should be able to access data based on their network location at a per-row and per-column granularity. When a user attempts to access particular types of data, the system applies logic to determine whether row, table, or column of data allowed to be accessed by the user device's IP address. Some data may be readable by the user device but not updateable (writable).

Thus, a user can have access to data in some rows, columns and/or cells but not have access to data in other rows, columns or cells.

Alternatively, or in addition to the other examples described herein, examples include any combination of the following:
wherein the set of database-level restrictions comprises at least one allowed IP address associated with connecting to the database;
the permissions component checks a set of allowed IP addresses associated with accessing any data on the database, wherein the application is permitted to connect to the database if the requesting IP address is included within the set of allowed IP addresses, and wherein the application is denied access to the database if the requesting IP address is absent from the set of allowed IP addresses;
a per-table restriction, wherein the permissions component checks a set of allowed IP addresses associated with accessing data in the selected table of the database, wherein the application is permitted to access the data in the selected table if the requesting IP address is included within the set of allowed IP addresses, and wherein the application is denied access the data in the selected table of the database if the requesting IP address is absent from the set of allowed IP addresses;
a per-column based restriction, wherein the permissions component checks a set of allowed IP addresses associated with accessing data in the selected column of the database, wherein the application is permitted to access the data in the selected column if the requesting IP address is included within the set of allowed IP addresses, and wherein the application is denied access the data in the selected column of the database if the requesting IP address is absent from the set of allowed IP addresses;
a per-row restriction, wherein the permissions component checks a set of allowed IP addresses associated with accessing data in the selected row of the database, wherein the application is permitted to access the data in the selected row if the requesting IP address is included within the set of allowed IP addresses, and wherein the application is denied access the data in the selected row of the database if the requesting IP address is absent from the set of allowed IP addresses;
a per-cell restriction, wherein the permissions component checks a set of allowed IP addresses associated with accessing data in the selected cell of the database, wherein the application is permitted to access the data in the selected cell if the requesting IP address is included within the set of allowed IP addresses for accessing both a column and a row associated with the selected cell, and wherein the application is denied access the data in the selected cell of the database if the requesting IP address is absent from the set of allowed IP addresses for accessing the column or the row associated with the selected cell;
a per-IP address read restriction, wherein the permissions component checks a set of allowed IP addresses associated with reading data from the selected column or the selected row of the database, wherein the application is permitted to access the read the data in the selected column or the selected row if the requesting IP address is included within the set of allowed IP addresses for reading data from the selected column or row, and wherein the application is denied read-access to the data in the selected column or the selected row of the database if the requesting IP address is absent from the set of allowed IP addresses for reading the data;
a per-IP address update restriction, wherein the permissions component checks a set of allowed IP addresses associated with updating data in the selected column or the selected row of the database, wherein the application is permitted to update the data in the selected column or the selected row if the requesting IP address is included within the set of allowed IP addresses for updating the data in the selected column or row, and wherein the application is denied write-access to update the data in the selected column or the selected row of the database if the requesting IP address is absent from the set of allowed IP addresses for updating the data;
a range of permissible IP addresses for accessing a table, a row or a column in the database;
a set of allowed IP addresses associated with at least one subnetwork;
receiving, from a user device, a request to access data in the at least one column or at least one row of the database via a network;
identifying, by a database manger component, a requesting IP address associated with the request;
comparing, by a permissions component, the requesting IP address associated with the request to a set of allowed IP address associated with the data in the at least one column or the at least one row of the database;
permitting, by the permissions component, the requested access to the data by the user device on condition the requesting IP address is included within the set of allowed IP addresses and a type of access associated with the request is allowed by a set of permissions assigned to the requesting IP address, wherein the type of access includes read access or write access;
denying, by an error handling component, the requesting access on condition the requesting IP address is absent from the set of allowed IP addresses or the type of access requested is disallowed by the set of permissions assigned to the requesting IP address at the database-level;
checking the set of allowed IP addresses associated with accessing any data on the database, wherein the user device is permitted to connect to the database if the requesting IP address is included within the set of allowed IP addresses, and wherein the user device is denied access to the database if the requesting IP address is absent from the set of allowed IP addresses;
checking, by the permissions component, the set of allowed IP addresses associated with accessing data in a selected table of the database, wherein the user device is permitted to access the data in the selected table if the requesting IP address is included within the set of allowed IP addresses, and wherein the user device is denied access the data in the selected table of the database if the requesting IP address is absent from the set of allowed IP addresses;
checking, by the permissions component, the set of allowed IP addresses associated with accessing data in a selected column of the database, wherein the user device is permitted to access the data in the selected column if the requesting IP address is included within the set of allowed IP addresses, and wherein the user device is denied access the data in the selected column of the database if the requesting IP address is absent from the set of allowed IP addresses;
checking a set of allowed IP addresses associated with accessing data in a selected row of the database, wherein the user device is permitted to access the data in the selected row if the requesting IP address is included within the set of allowed IP addresses, and wherein the user device is denied access the data in the selected row of the database if the requesting IP address is absent from the set of allowed IP addresses;
checking a set of allowed IP addresses associated with accessing data in the selected cell of the database, wherein the user device is permitted to access the data in the selected cell if the requesting IP address is included within the set of allowed IP addresses for accessing both a column and a row associated with the selected cell, and wherein the user device is denied access the data in the selected cell of the database if the requesting IP address is absent from the set of allowed IP addresses for accessing the column or the row associated with the selected cell;
checking a set of allowed IP addresses associated with reading data from the selected column or the selected row of the database, wherein the user device is permitted to read the data in the selected column or the selected row if the requesting IP address is included within the set of allowed IP addresses for reading data from the selected column or row, and wherein the user device is denied read-access to the data in the selected column or the selected row of the database if the requesting IP address is absent from the set of allowed IP addresses for reading the data;
checking a set of allowed IP addresses associated with updating data in the selected column or the selected row of the database, wherein the user device is permitted to update the data in the selected column or the selected row if the requesting IP address is included within the set of allowed IP addresses for updating the data in the selected column or row, and wherein the user device is denied write-access to update the data in the selected column or the selected row of the database if the requesting IP address is absent from the set of allowed IP addresses for updating the data;
adding a set of database-level restrictions onto at least a portion of data in a database on a data storage device, the set of database-level restriction comprising a set of allowed IP addresses for accessing the at least the portion of the data in a table, a column or a row of the database;
comparing a requesting IP address associated with a read or write request received from an application with the set of allowed IP addresses prior to permitting access to the at least the portion of the data in the table, column or the row of the database;
granting the read or write request on condition the requesting IP address is included within the set of allowed IP addresses for the table, the column or the row of the database associated with the request; and
initiating error handling on condition the requesting IP address is absent from the set of allowed IP addresses.

At least a portion of the functionality of the various elements in FIG. 1, FIG. 2, FIG. 3, FIG. 4, FIG. 5 and FIG. 6 can be performed by other elements in FIG. 1, FIG. 2, FIG. 3, FIG. 4, FIG. 5 and FIG. 6, or an entity (e.g., processor 106, web service, server, application program, computing device, etc.) not shown in FIG. 1, FIG. 2, FIG. 3, FIG. 4, FIG. 5 and FIG. 6.

In some examples, the operations illustrated in FIG. 7, FIG. 8, FIG. 9, FIG. 10, FIG. 11 and FIG. 12 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for application-level database access restrictions. For example, the elements illustrated in FIG. 1, FIG. 2, FIG. 3, FIG. 4, FIG. 5 and FIG. 6, such as when encoded to perform the operations illustrated in FIG. 7, FIG. 8, FIG. 9, FIG. 10, FIG. 11 and FIG. 12, constitute exemplary means for receiving a request to access data in the at least one column or at least one row of the database via a network; exemplary means for identifying a requesting IP address associated with the request; exemplary means for comparing the requesting IP address associated with the request to a set of allowed IP address associated with the data in the at least one column or the at least one row of the database; exemplary means for permitting the requested access to the data by the user device on condition the requesting IP address is included within the set of allowed IP addresses and a type of access associated with the request is allowed by a set of permissions assigned to the requesting IP address; and exemplary means for denying the requesting access on condition the requesting IP address is absent from the set of allowed IP addresses or the type of access requested is disallowed by the set of permissions assigned to the requesting IP address at the database-level.

Other non-limiting examples provide one or more computer storage devices having a first computer-executable instructions stored thereon for providing application-level database restrictions. When executed by a computer, the computer performs operations including adding a set of database-level restrictions onto at least a portion of data in a database on a data storage device; comparing a requesting IP address associated with a read or write request received from an application with the set of allowed IP addresses prior to permitting access to the at least the portion of the data in the table, column or the row of the database; granting the read or write request on condition the requesting IP address is included within the set of allowed IP addresses for the table, the column or the row of the database associated with the request; and initiating error handling on condition the requesting IP address is absent from the set of allowed IP addresses.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there can be additional elements other than the listed elements. The term “exemplary” is intended to mean “an example of ” The phrase “one or more of the following: A, B, and C” means “at least one of A and/or at least one of B and/or at least one of C.”

In an exemplary embodiment, one or more of the exemplary embodiments include one or more localized Internet of Things (IoT) devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system can be reduced significantly. For example, whenever localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data can include a key kernel index summary of the data as created under nominal conditions. In an exemplary embodiment, the kernel encodes relatively recently acquired intermittent data (“KRI”). As a result, in an exemplary embodiment, KRI includes a continuously utilized near term source of data, but KRI can be discarded depending upon the degree to which such KRI has any value based on local processing and evaluation of such KRI. In an exemplary embodiment, KRI may not even be utilized in any form if it is determined that KRI is transient and can be considered as signal noise. Furthermore, in an exemplary embodiment, the kernel rejects generic data to provide a modified kernel (“KRG”) by filtering incoming raw data using a stochastic filter that thereby provides a predictive model of one or more future states of the system and can thereby filter out data that is not consistent with the modeled future states which can, for example, reflect generic background data. In an exemplary embodiment, KRG incrementally sequences all future undefined cached kernels of data to filter out data that can reflect generic background data. In an exemplary embodiment, KRG further incrementally sequences all future undefined cached kernels having encoded asynchronous data to filter out data that can reflect generic background data.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for application-level database access restrictions using internet protocol (IP) addresses, the system comprising:
a memory;
at least one processor communicatively coupled to the memory;
a data storage device comprising a database storing data;
a property manager component, implemented on the at least one processor, adds a set of database-level restrictions onto at least a portion of data in the database, the set of database-level restriction comprising at least one allowed IP address for accessing the at least the portion of the data in at least one column or at least one row of the database;
a request manager component, implemented on the at least one processor, receives a request from an application to access the portion of the data in the at least one column or the at least one row of the database via a network;
a permissions component, implemented on the at least one processor, compares a requesting IP address associated with the request to the at least one allowed IP address for accessing the portion of the data to determine whether the requesting IP address is allowed to access the data and whether a type of access requested is permitted by the set of database-level restrictions;
the permissions component grants the request on condition the set of database-level restrictions allows the requesting IP address and the type of access associated with the portion of the data; and
an error handling component, implemented on the at least one processor, outputs an error to a user device associated with the request.

2. The system of claim 1, wherein the set of database-level restrictions comprises at least one allowed IP address associated with connecting to the database and further comprising:
the permissions component checks a set of allowed IP addresses associated with accessing the data on the database, wherein the application is permitted to connect to the database if the requesting IP address is included within the set of allowed IP addresses, and wherein the application is denied access to the database if the requesting IP address is absent from the set of allowed IP addresses.

3. The system of claim 1, wherein the set of database-level restrictions comprises:
a per-table restriction, wherein the permissions component checks a set of allowed IP addresses associated with accessing the data in a selected table of the database, wherein the application is permitted to access the data in the selected table if the requesting IP address is included within the set of allowed IP addresses, and wherein the application is denied access the data in the selected table of the database if the requesting IP address is absent from the set of allowed IP addresses.

4. The system of claim 1, wherein the set of database-level restrictions comprises:
a per-column based restriction, wherein the permissions component checks a set of allowed IP addresses associated with accessing the data in a selected column of the database, wherein the application is permitted to access the data in the selected column if the requesting IP address is included within the set of allowed IP addresses, and wherein the application is denied access the data in the selected column of the database if the requesting IP address is absent from the set of allowed IP addresses.

5. The system of claim 1, wherein the set of database-level restrictions comprises:
a per-row restriction, wherein the permissions component checks a set of allowed IP addresses associated with accessing the data in a selected row of the database, wherein the application is permitted to access the data in the selected row if the requesting IP address is included within the set of allowed IP addresses, and wherein the application is denied access the data in the selected row of the database if the requesting IP address is absent from the set of allowed IP addresses.

6. The system of claim 1, wherein the set of database-level restrictions comprises:
a per-cell restriction, wherein the permissions component checks a set of allowed IP addresses associated with accessing the data in a selected cell of the database, wherein the application is permitted to access the data in the selected cell if the requesting IP address is included within the set of allowed IP addresses for accessing both a column and a row associated with the selected cell, and wherein the application is denied access the data in the selected cell of the database if the requesting IP address is absent from the set of allowed IP addresses for accessing the column or the row associated with the selected cell.

7. The system of claim 1, wherein the set of database-level restrictions comprises:
a per-IP address read restriction, wherein the permissions component checks a set of allowed IP addresses associated with reading the data from a selected column or a selected row of the database, wherein the application is permitted to read the data in the selected column or the selected row if the requesting IP address is included within the set of allowed IP addresses for reading the data from the selected column or the selected row, and wherein the application is denied read-access to the data in the selected column or the selected row of the database if the requesting IP address is absent from the set of allowed IP addresses for reading the data.

8. The system of claim 1, wherein the set of database-level restrictions comprises:
a per-IP address update restriction, wherein the permissions component checks a set of allowed IP addresses associated with updating the data in a selected column or the selected row of the database, wherein the application is permitted to update the data in the selected column or the selected row if the requesting IP address is included within the set of allowed IP addresses for updating the data in the selected column or the selected row, and wherein the application is denied write-access to update the data in the selected column or the selected row of the database if the requesting IP address is absent from the set of allowed IP addresses for updating the data.

9. The system of claim 1, wherein the set of database-level restrictions further comprises:
a range of permissible IP addresses for accessing a table, a row or a column in the database.

10. The system of claim 1, wherein the set of database-level restrictions further comprises:
a set of allowed IP addresses associated with at least one subnetwork.

11. A computer-implemented method for restricting database access, the computer-implemented method comprising:
receiving, from a user device, a request to access data in at least one column or at least one row of the database via a network;
identifying, by a database manger component, a requesting IP address associated with the request;
comparing, by a permissions component, the requesting IP address associated with the request to a set of allowed IP address associated with the data in the at least one column or the at least one row of the database;
permitting, by the permissions component, the requested access to the data by the user device on condition the requesting IP address is included within the set of allowed IP addresses and a type of access associated with the request is allowed by a set of permissions assigned to the requesting IP address, wherein the type of access includes read access or write access; and
denying, by an error handling component, the requesting access on condition the requesting IP address is absent from the set of allowed IP addresses or the type of access requested is disallowed by the set of permissions assigned to the requesting IP address at the database-level.

12. The computer-implemented method of claim 11, further comprising:
checking the set of allowed IP addresses associated with accessing the data on the database, wherein the user device is permitted to connect to the database if the requesting IP address is included within the set of allowed IP addresses, and wherein the user device is denied access to the database if the requesting IP address is absent from the set of allowed IP addresses.

13. The computer-implemented method of claim 11, further comprising:
checking, by the permissions component, the set of allowed IP addresses associated with accessing the data in a selected table of the database, wherein the user device is permitted to access the data in the selected table if the requesting IP address is included within the set of allowed IP addresses, and wherein the user device is denied access the data in the selected table of the database if the requesting IP address is absent from the set of allowed IP addresses.

14. The computer-implemented method of claim 11, further comprising:
checking, by the permissions component, the set of allowed IP addresses associated with accessing the data in a selected column of the database, wherein the user device is permitted to access the data in the selected column if the requesting IP address is included within the set of allowed IP addresses, and wherein the user device is denied access the data in the selected column of the database if the requesting IP address is absent from the set of allowed IP addresses.

15. The computer-implemented method of claim 11, further comprising:
checking the set of allowed IP addresses associated with accessing the data in a selected row of the database, wherein the user device is permitted to access the data in the selected row if the requesting IP address is included within the set of allowed IP addresses, and wherein the user device is denied access the data in the selected row of the database if the requesting IP address is absent from the set of allowed IP addresses.

16. The computer-implemented method of claim 11, further comprising:
checking a set of allowed IP addresses associated with accessing the data in a selected cell of the database, wherein the user device is permitted to access the data in the selected cell if the requesting IP address is included within the set of allowed IP addresses for accessing both a column and a row associated with the selected cell, and wherein the user device is denied access the data in the selected cell of the database if the requesting IP address is absent from the set of allowed IP addresses for accessing the column or the row associated with the selected cell.

17. The computer-implemented method of claim 11, further comprising:
checking the set of allowed IP addresses associated with reading the data from a selected column or a selected row of the database, wherein the user device is permitted to read the data in the selected column or the selected row if the requesting IP address is included within the set of allowed IP addresses for reading the data from the selected column or the selected row, and wherein the user device is denied read-access to the data in the selected column or the selected row of the database if the requesting IP address is absent from the set of allowed IP addresses for reading the data.

18. The computer-implemented method of claim 11, further comprising:
checking the set of allowed IP addresses associated with updating the data in a selected column or a selected row of the database, wherein the user device is permitted to update the data in the selected column or the selected row if the requesting IP address is included within the set of allowed IP addresses for updating the data in the selected column or the selected row, and wherein the user device is denied write-access to update the data in the selected column or the selected row of the database if the requesting IP address is absent from the set of allowed IP addresses for updating the data.

19. The computer-implemented method of claim 11, wherein the set of allowed IP addresses includes a range of IP addresses.

20. One or more computer storage media, having computer-executable instructions for customized database access restrictions at the application level that, when executed by a computer cause the computer to perform operations comprising: adding a set of database-level restrictions onto at least a portion of data in a database on a data storage device, the set of database-level restriction comprising a set of allowed IP addresses for accessing the at least the portion of the data in a table, a column or a row of the database;
comparing a requesting IP address associated with a read request or a write request received from an application with the set of allowed IP addresses prior to permitting access to the at least the portion of the data in the table, the column or the row of the database;
granting the read request or the write request on condition the requesting IP address is included within the set of allowed IP addresses for the table, the column or the row of the database associated with the request; and
initiating error handling on condition the requesting IP address is absent from the set of allowed IP addresses.
